(19) United States
(12) Patent Application Publication
(10) Pub. No.: US 2013/0101010 A1
(43) Pub. Date: Apr. 25, 2013

(54) METHOD AND APPARATUS FOR JOINT DECODING AND EQUALIZATION

(71) Applicants: Raúl Alejandro Casas, Daylestown, PA (US); Stephen Leonard Biracree, Rochester, NY (US); Slobodan Simovich, San Francisco, CA (US); Thomas Joseph Endres, Seattle, CA (US); Anand Mahendra Shah, San Francisco, CA (US)

(72) Inventors: Raúl Alejandro Casas, Daylestown, PA (US); Stephen Leonard Biracree, Rochester, NY (US); Slobodan Simovich, San Francisco, CA (US); Thomas Joseph Endres, Seattle, CA (US); Anand Mahendra Shah, San Francisco, CA (US)

(21) Appl. No.: 13/448,805

(22) Filed: Apr. 17, 2012

Related U.S. Application Data
(63) Continuation-in-part of application No. 12/229,725, filed on Aug. 26, 2008, now Pat. No. 8,170,128.
(60) Provisional application No. 60/967,515, filed on Sep. 5, 2007.

(51) Int. Cl. H04L 27/01

(52) U.S. Cl. CPC H04L 27/01
USPC 375/233

(57) ABSTRACT

The current application is directed to joint decoding and equalization using a decision feedback equalizer. An example method to which the current application and certain of the current claims are directed uses joint trellis decoding and decision feedback equalization to efficiently estimate non-contiguous symbols using non-contiguous equalizer outputs. The estimation process uses all new possibilities of symbol values, rather than old decision feedback symbol estimates.

### CROSS REFERENCE TO RELATED APPLICATIONS

This application is a continuation-in-part of U.S. application Ser. No. 12/229,725, filed Aug. 26, 2008, which claims the benefit of Provisional Application No. 60/967,515, filed Sep. 5, 2007.

### TECHNICAL FIELD

The current application is related to joint decoding and equalization using a multiple-non-contiguous-symbol-estimation decision feedback equalizer.

### BACKGROUND

Equalization in a digital receiver is a process in which noise, multipath interference, and other interferences incurred in the broadcast of a digital signal are attempted to be removed from the received signal in order to restore the originally transmitted digital signal. Since the characteristics of the broadcast channel are rarely known a priori to the receiver, and can change dynamically, equalizers are usually implemented using adaptive filters.

Most state-of-the-art digital receivers use some type of decision feedback equalizer (DFE), because decision feedback equalizers provide superior inter-symbol interference (ISI) cancellation with less noise gain than equalizers that employ only a Finite Impulse Response (FIR) structure. A DFE acts to cancel ISI by subtracting filtered symbol estimates from the received waveform. Austin first proposed a DFE, in a report entitled “Decision feedback equalization for digital communication over dispersive channels,” MIT Lincoln Labs Technical Report No. 437, Lexington, Mass., August 1967.

Nearly all modern digital-communication systems use some type of channel coding at the transmitter and complementary decoding at the receiver. Channel coding typically introduces redundancy or overhead in a signal, which provides for better estimation of the transmitted signal at the expense of reduced bandwidth. A common type of channel coding uses trellis coded modulation techniques, as described, for example, in chapter 3 of Trellis Coding, C. Schlegel, IEEE Press, NY, 1997.

Certain currently available techniques combine equalization and decoding to provide better overall recovered-signal error rates. For example, in “Delayed-decision feedback sequence estimation,” by A. Duel-Hallen and C. Heegard, in IEEE Transactions on Communications, vol. 37, no. 5, May 1989, a tunable detection method is introduced for a contiguous block of symbols in which the length of a block is tunable. This method uses a reduced-state search which incorporates information from the feedback filter to calculate path metrics. The information and symbol estimates are constrained to be contiguous.

In “Reduced-state sequence estimation with set partitioning and decision feedback,” by M. Eyuboglu and S. Qureshi, in IEEE Transactions on Communications, vol. 36, no. 1, January 1988, a conventional Viterbi method is used to search a reduced-state trellis, constructed using set partitioning, so that the complexity of the maximum likelihood approach is reduced, with little loss of performance.

In “Block decision feedback equalization,” by D. Williamson et al., in IEEE Transactions on Communications, vol. 40, no. 2, February 1992, a generalization of the DFE is presented where a contiguous block of data is used to estimate a contiguous block of symbols. The method is tunable in the block length of data used and the block length of symbols estimated, and is shown to be a generalization of the maximum likelihood sequence estimator and the maximum symbol-by-symbol a posteriori detector.

In “Decision feedback equalization with trellis decoding,” by R. Gitlin and N. Zervos, in U.S. Pat. No. 5,056,117, Oct. 8, 1991, a trellis decoder is used to provide tentative decisions derived from survival paths of the Viterbi method to the feedback filter in the DFE in order to minimize feedback errors.

### SUMMARY

The current application is directed to joint decoding and equalization using a decision feedback equalizer. An example method to which the current application and certain of the current claims are directed uses joint trellis decoding and decision feedback equalization to efficiently estimate non-contiguous symbols using non-contiguous equalizer outputs. The estimation process uses all new possibilities of symbol values, rather than old decision feedback symbol estimates.

### BRIEF DESCRIPTION OF DRAWINGS

FIG. 1 shows a typical currently available digital television broadcast communication system.

FIG. 2 shows a typical currently available digital receiver system.

FIG. 3 shows a currently available decision feedback equalizer.

FIG. 4 shows equalizer circuitry that represents an example of the methods and systems to which the current application is directed.

FIG. 5 shows a top level view of a hyper trellis decoder used in an example of the methods and systems to which the current application is directed.

FIG. 6 shows an observation calculator used in an example of the methods and systems to which the current application is directed.

FIG. 7 shows a delay transition metric calculator used in an example of the methods and systems to which the current application is directed.

FIG. 8 shows a current transition metric calculator used in an example of the methods and systems to which the current application is directed.

FIG. 9 shows a branch metric calculator used in an example of the methods and systems to which the current application is directed.

FIG. 10 shows a state transition metric calculator used in an example of the methods and systems to which the current application is directed.

FIG. 11 shows symbol error rate versus signal to noise ratio results comparing a currently available system with an example of the systems to which the current application is directed.

FIG. 12 shows trellis state transitions for a currently available ATSC trellis decoder.

FIG. 13 shows trellis state transitions used in an example of the methods and systems to which the current application is directed.

### DETAILED DESCRIPTION

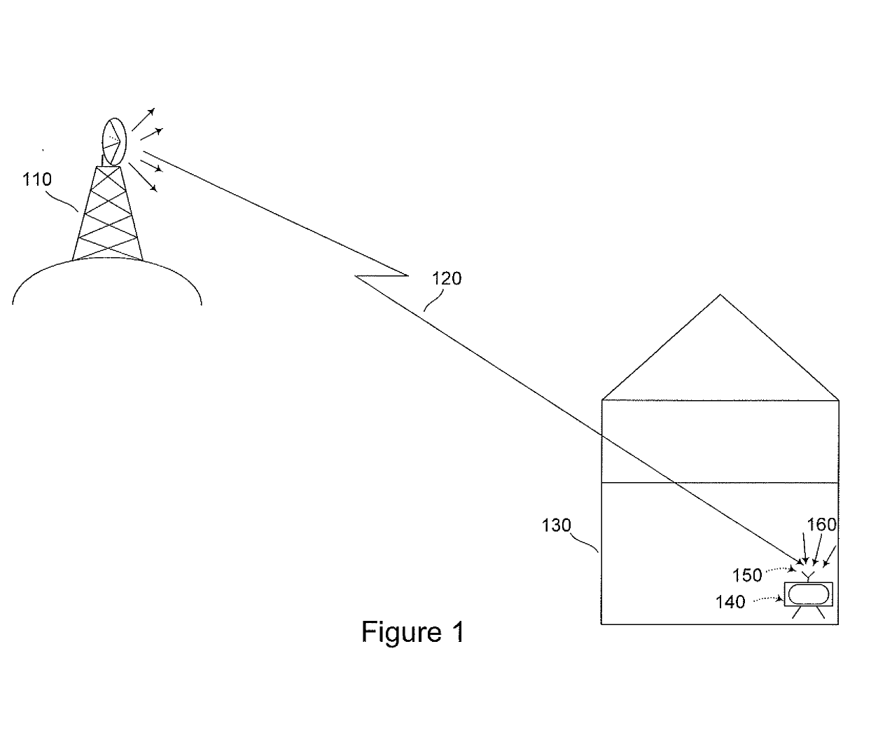

FIG. 1 depicts a typical currently available digital television broadcast communication system. Transmitter station 110 broadcasts Digital Television (DTV) signal 120, which radiates through a house 130 to an antenna 150. The induced penetration loss of the RF carrier's signal power through the house 130 can be significant, easily 20 dB. The antenna 150 is usually in close proximity to television 140 or can be remotely connected to television 140. Antenna 150 also receives multipath signals, shown by multiple arrows 160 in FIG. 1, which can be caused by reflections from other buildings or items interior to house 130, including walls, furniture, persons, appliances, and other objects and features. Furthermore, in most viewing environments, the television 140 is located in a communal part of house 130, so that reflections from moving persons, pets, and other moving objects induce time varying multipath signals 160. Reflections from moving cars and/or airplanes may cause further time variations in multipath signals 160. These multipath signals result in distortions, or echoes, in the received signal that were not present in the originally transmitted signal.

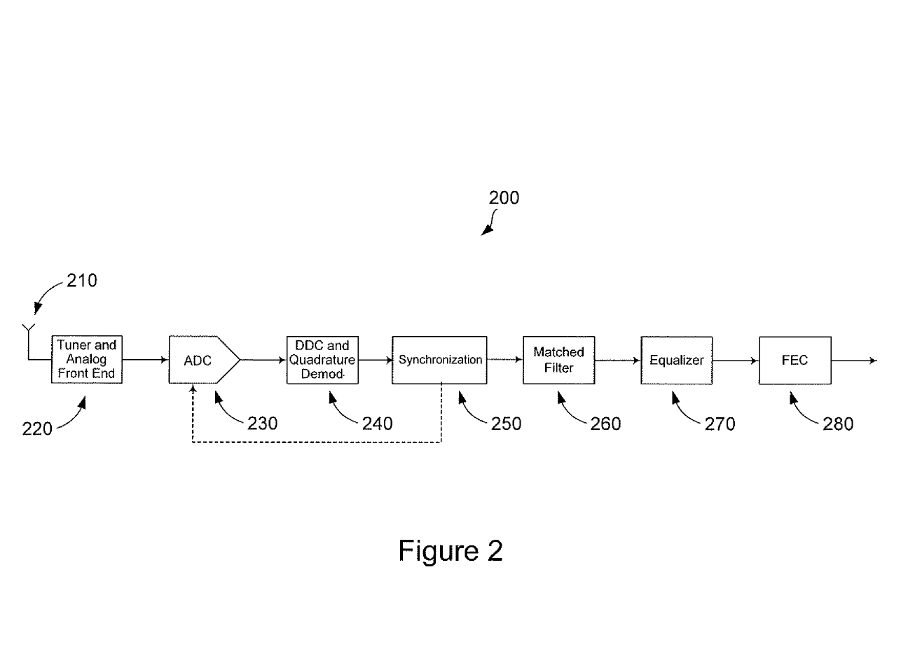

FIG. 2 shows a typical currently available digital receiver system 200. Antenna 210 receives DTV broadcast signal 120, and is coupled to Tuner and Analog Front End module 220. Tuner and Analog Front End module 220 tunes to the proper broadcast channel, performs level setting, synchronization, and filtering, and couples the signal to ADC 230. ADC 230 digitizes the analog signal, typically 10-12 bits for DTV, and supplies the bit stream to the DDC and Quadrature Demodulation module 240. The DDC and quadrature demodulation module 240 performs direct digital downconversion (DDC) and an in-phase/quadrature-phase split into the complex near-baseband. In addition, other filtering may be used; for example, rejection of adjacent broadcasts. The near-baseband signal from DDC and quadrature demodulation module 240 is coupled to synchronization module 250. Synchronization module 250 aligns the sample rate and phase of the received samples to the transmitted data samples, typically by either interpolating the data or adjusting the sample clock of ADC 230, shown in phantom. Furthermore, carrier phase and frequency recovery may be done using the pilot tone that is embedded into the DTV data spectrum, using well-known methods. Timed data from synchronization module 250 is supplied to matched filter 260, which usually performs square-root raised cosine filtering that is matched to the pulse shape filter applied at the transmitter 110. The output of matched filter 260 is supplied to Equalizer 270, which performs adaptive equalization to mitigate inter-symbol interference incurred in the broadcast channel. Furthermore, equalizer 270 may include a fine carrier recovery loop, translating the data to a precise baseband. Equalizer 270 provides an equalized signal to FEC 280, which performs forward error correction to minimize the received bit error rate and provides the recovered digital video signal, usually as MPEG packets, which can be decoded and viewed on a television. The presently disclosed method and sub-system pertain to the equalizer 270 in the digital receiver.

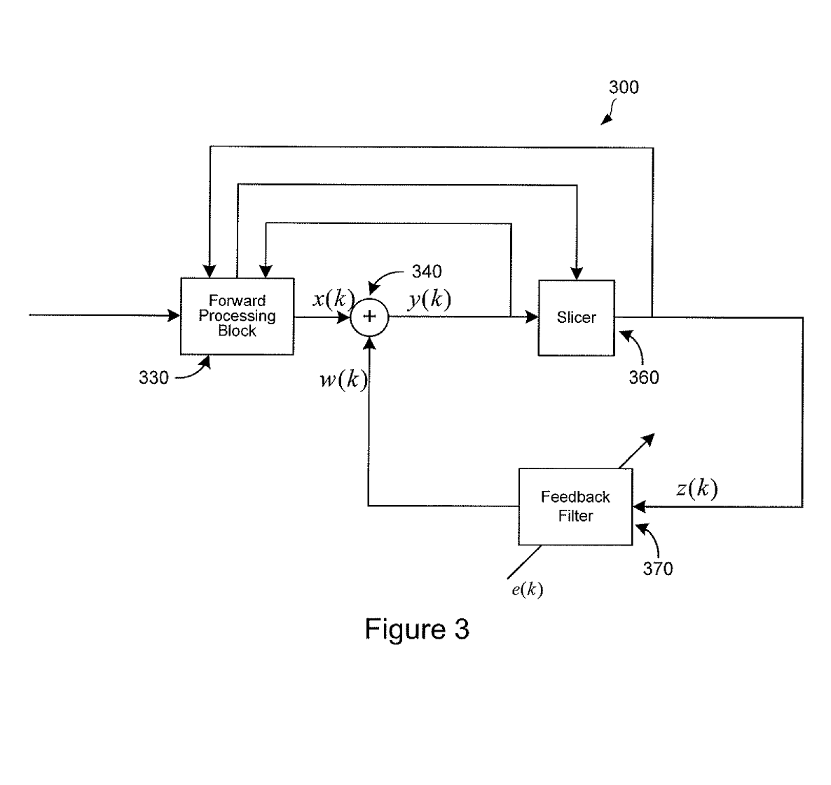

FIG. 3 depicts a block diagram of a currently available equalizer and encapsulates the equalizer architectures described in “Feasibility of reliable 8-VSB reception” by C. H. Strolle et al, Proceedings of the NAB Broadcast Engineering Conference,” Las Vegas, Nev., pp. 483-488, Apr. 8-13, 2000, among other currently available equalizer architectures. The equalizer in FIG. 3 is suitable for Vestigial Sideband (VSB) signals, for example, in accordance with the ATSC DTV broadcast standard. The equalizer in FIG. 3 is also suitable for quadrature amplitude modulation (QAM) signals, encapsulating the equalizer architecture described in “Carrier independent blind initialization of a DFE,” by T. J. Endres et al., in Proceedings of the IEEE Workshop on Signal Processing Advances in Wireless Communications, Annapolis, Md., May 1999.

Forward processing block 330 encompasses multiple currently available signal processing functions, and may include circuitry for adaptive forward filtering, carrier recovery, error term generation, and other functionality. See “Phase detector in a carrier recovery network for a vestigial Sideband signal,” U.S. Pat. No. 5,706,057 issued Jan. 6, 1998, by C. H. Strolle et al., for carrier recovery techniques suitable to VSB signals. For QAM signals, decision-directed carrier estimation techniques are described in Chapter 16 of Digital Communication—Second Edition, Lee and Messerschmitt, Kluwer Academic Publishers, Boston, Mass., 1997. See Theory and Design of Adaptive Filters, New York, John Wiley and Sons, 1987, by Treichler et al for a description of adaptive filters, including forward adaptive filtering and error term generation.

Forward processing block 330 receives a timed and data-synchronized signal, or input samples, from front-end signal processing blocks of the digital receiver; for example, as shown in FIG. 2, and produces a forward-filtered timed and data-synchronized signal output x(k). Forward processing block 330 also receives soft decision sample y(k) input to slicer 360 as well as output from slicer 360. Forward processing block 330 may further provide output to slicer 360; for example, to provide sine and cosine terms to slicer 360 when slicer 360 forms passband samples, as described in “Carrier independent blind initialization of a DFE,” by T. J. Endres et al., in Proceedings of the IEEE Workshop on Signal Processing Advances in Wireless Communications, Annapolis, Md., May 1999. Gain correction terms may also be supplied to slicer 360 from forward processing block 330, with gain and phase correction terms represented by the notation β(k)·e^{jθ(k)} in FIG. 3.

Adder 340 combines x(k) with feedback filter 370 output w(k) to provide sample y(k), referred to as the “soft-decision sample.” Combining x(k) with w(k) can either be done with addition or subtraction, depending upon other polarity choices made. Soft decision sample y(k) is provided to slicer 360. Slicer 360 produces a symbol estimate, also referred to as a “hard decision sample.” Slicer 360 can be a nearest-element decision device, selecting the source symbol with minimum Euclidean distance to the soft decision sample, or can take advantage of the channel coding. For example, a partial trellis decoder is used as slicer 360 in “A method of estimating trellis encoded symbols utilizing simplified trellis decoding,” U.S. Pat. No. 6,178,209, issued Jan. 23, 2001, by S. N. Hulyalkar et al. Slicer 360 may also receive an input signal from forward processing block 330, for example, including sine and cosine terms which may be used for rotation and de-rotation in accordance with previously cited currently available techniques.

The output from slicer 360 is used to form regressor sample z(k) for the feedback filter 370. The feedback filter 370 receives regressor samples z(k) and produces output sample w(k) to adder 340. The feedback filter 370 is generally implemented with adaptive coefficients, and is therefore provided error term e(k) for coefficient adjustment. Error term e(k) may be generated in forward processing block 330 or elsewhere in the receiver architecture.

The adaptive filter contained in forward processing block 330 and the feedback filter 370 may include real-valued or complex-valued coefficients, may process real-valued or complex-valued data, and may adjust coefficients or blocks of coefficients using real-valued or complex-valued errors.

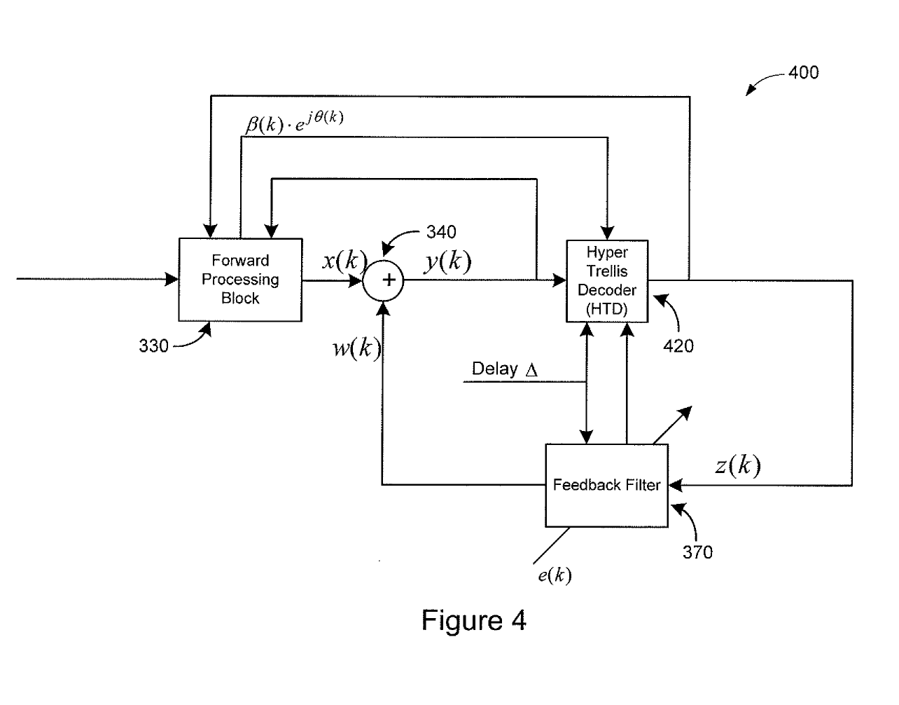

FIG. 4 shows equalizer circuitry that is an example of a multiple-non-contiguous-symbol-estimation decision feedback equalizer to which the current application is directed. In this example multiple-non-contiguous-symbol-estimation decision feedback equalizer, a hyper trellis decoder (HTD) 420 replaces the slicer 360 from FIG. 3. Unlike the slicer 360, the hyper trellis decoder 420 receives an input from feedback filter 370 corresponding to the coefficient of the filter at delay Δ or some measure of the coefficient at delay Δ. The programmable delay Δ is provided to hyper trellis decoder 420 and feedback filter 370. Unlike the slicer 360 and other currently available sub-components which use input from feedback filter 370, the hyper trellis decoder 420 uses maximum-likelihood techniques to efficiently estimate non-contiguous symbols, separated by delay Δ, whereby the contribution of the symbol estimate at delay Δ is removed and all possible symbols under the channel-coding constraint are tested to determine the output symbol.

The symbol estimate produced by hyper trellis decoder 420 is more reliable than that of conventional currently available techniques, including the slicer 360 used in the prior-art device shown in FIG. 3, and can be used to directly or indirectly produce input data to feedback filter 370. Furthermore, the symbol estimate produced by hyper trellis decoder 420 can be used for error-term generation. For example, the symbol estimate can be used in the forward filter processing block 330, or elsewhere, to adjust adaptive filters in equalizer circuitry 400. The symbol estimate produced by hyper trellis decoder 420 can also be used in carrier-estimation techniques. The symbol estimate produced in hyper trellis decoder 420 may be further rotated or translated in frequency; for example, by sine and cosine terms provided by forward processing block 330, depending on the specifics of the architecture of the equalizer circuitry 400 and/or the signal protocol.

The programmable delay Δ provided to hyper trellis decoder 420 and feedback filter 370 can be static, or can alternatively be adjusted to optimize performance, according to one or more rules. For example, a measure of the coefficient magnitudes in feedback filter 370 can be used to select delay Δ throughout demodulator operation.

In the disclosed examples, provided below for illustrative purposes, the described trellis coding is consistent with the ATSC standard, ATSC Digital Television Standard (A/53) Revision E. Furthermore, a trellis index, TrellisIndex, 0 . . . 11, accommodating the twelve interleaved trellis encoders in the ATSC standard, is shown. The system and methods to which the current application is directed may employ other types of trellis codes as well as additional types of codes.

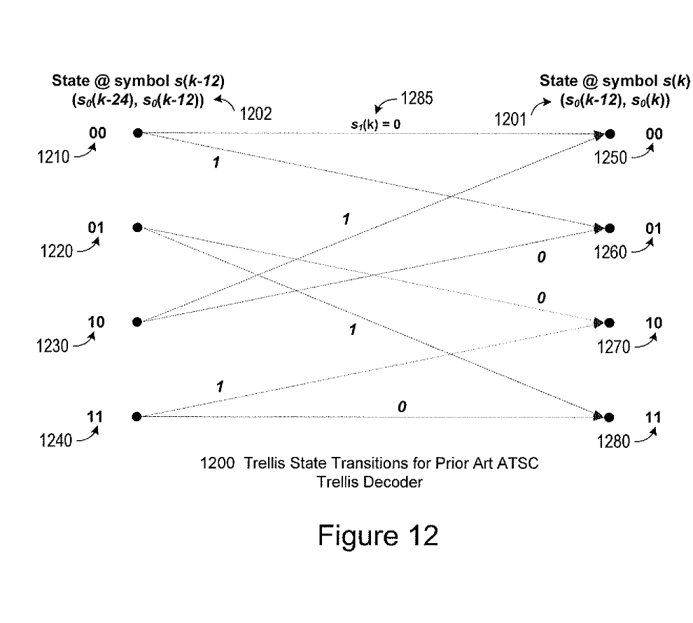

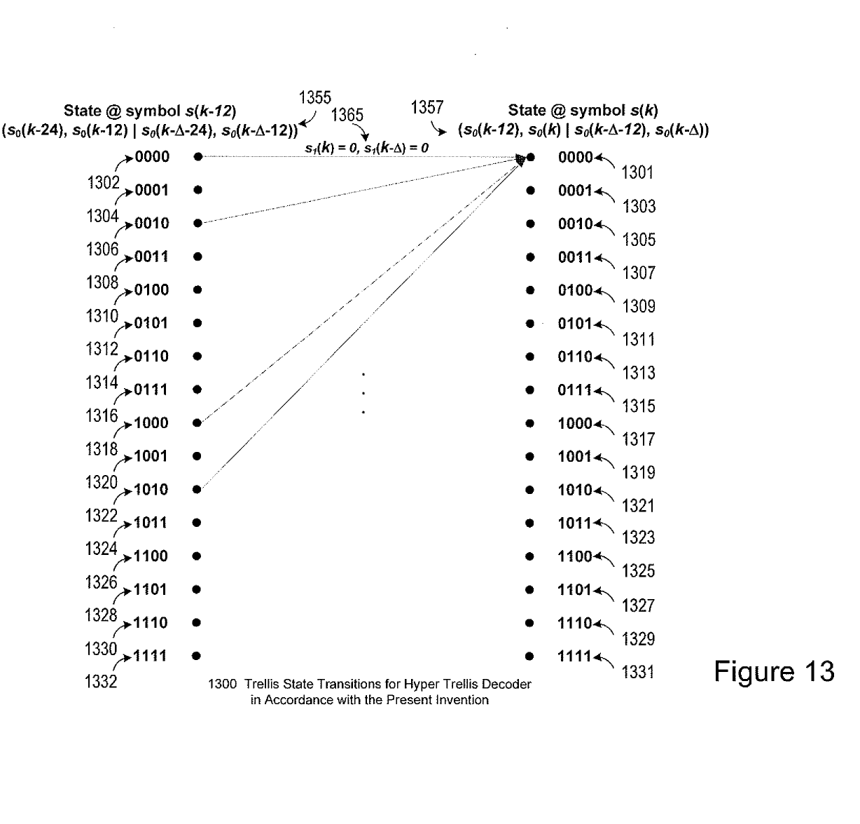

For illustrative purposes, the current disclosure considers the particular two-dimensional case in which non-contiguous symbols s(k) and s(k−Δ), Δ>0, are jointly estimated. Note that Δ may be expressed in units of time or in symbol positions within a symbol stream. Non-contiguous symbols are not adjacent to one another in a symbol stream and are separated, in time, by more than the time that elapses during the transmission of two adjacent symbols in a symbol stream. By contrast, contiguous symbols are separated in time by an amount of time greater than the time that elapses during the transmission of a single symbol but less than the time that elapses during the transmission of two adjacent symbols in a symbol stream. The four-state Trellis 1200 shown in FIG. 12, which describes the possible paths taken by the states of each one of the twelve ATSC convolutional codes, is extended to the sixteen-state “Hypertrellis” 1300 in FIG. 13. Hence, a Hypertrellis for ATSC then consists of twelve parallel Hypertrellis decoders 1300, each corresponding to one of the twelve parallel encoders. In FIG. 12, each of the twelve trellises is defined by the state of the convolutional code (s₀(k−12), s₀(k)) 1201 at time k with transitions given by input bits from state (s₀(k−24), s₀(k−12)) 1202. Each transition of the trellis from one of 1250, 1260, 1270, or 1280, which comprise state (s₀(k−24), s₀(k−12)) 1202, to one of 1210, 1220, 1230, or 1240, which comprise state (s₀(k−12), s₀(k)) 1201, consists of two parallel branches since the transitions are driven by bit s₁(k) 1285 while bit s₂(k) toggles independently of the encoder.

The Hypertrellis 1300 in FIG. 13 is defined by concatenating the states S0=(s₀(k−12),s₀(k)) and SΔ=(s₀(k−Δ−12),s₀(k−Δ)) of the trellises, at times k and k−Δ respectively, to form a sixteen state trellis with states (s₀(k−12),s₀(k)|s₀(k−Δ−12),s₀(k−Δ)) 1357, Δ>0. Each transition from one of 1301-1331 (odd numbers only), which comprise state (s₀(k−12),s₀(k)|s₀(k−Δ−12),s₀(k−Δ)) 1357, to one of 1302-1332 (even numbers only), which comprise state (s₀(k−24),s₀(k−12)|s₀(k−Δ−24),s₀(k−Δ−12)) 1355, consists of four branches since the transitions are driven by bits s₁(k) and s₁(k−Δ) 1365 while bits s₂(k) and s₂(k−Δ) toggle independently. Thus, in the two-dimensional case, the HTD is a Viterbi decoder for the hypertrellis 1300 in FIG. 13, using the signals collected from the decision feedback equalizer structure in FIG. 4. The currently disclosed methods and systems can be modified to estimate more than two non-contiguous symbols such as (s(k), s(k−Δ₁), . . . , s(k−Δ_{N})). In the two-dimensional case, the HTD generates branch metrics for the hypertrellis in FIG. 13 using the soft decision sample y(k), calculated as

y(k)=x(k)−[z(k−1)·α₁+z(k−2)·α₂+ . . . +z(k−N)·α_{N}]

where z(k) are the estimates of symbols s(k).

The HTD generates the observations y(k)+z(k−Δ)·α₆₆ and y(k−Δ) to estimate symbols s(k) and s(k−Δ). To better understand how the HTD works, consider the case where past symbols are correct (i.e. z(k−δ)=s(k−δ) for δ>0) and x(k) is well modeled as a linear combination of the transmitted symbol plus noise u(k), i.e.

x(k)=s(k)+s(k−1)·α₁+s(k−2)·α₂+ . . . +s(k−N)·α_{N}+u(k).

Then, the observations generated by the HTD reduce to

y(k)+z(k−Δ)·α_{Δ}=s(k)+s(k−Δ)·α₆₆+u(k)

y(k−Δ)=s(k−Δ)=s(k−Δ)+u(k−Δ)

Notice that these observations are linked by the delayed symbol s(k−Δ) and the coefficient α_{Δ}. From these observations, the HTD generates the following branch metrics for the hypertrellis in FIG. 13:

BMᵢⱼ=[y(k)+z(k−Δ)·α₆₆ −aᵢ−aⱼ·α_{Δ}]²+[y(k−Δ)−aⱼ]²

where a_{i,j} ε A . These branch metrics are subsequently used to calculate path metrics of the trellis in FIG. 13. This process and its efficient implementation are next described.

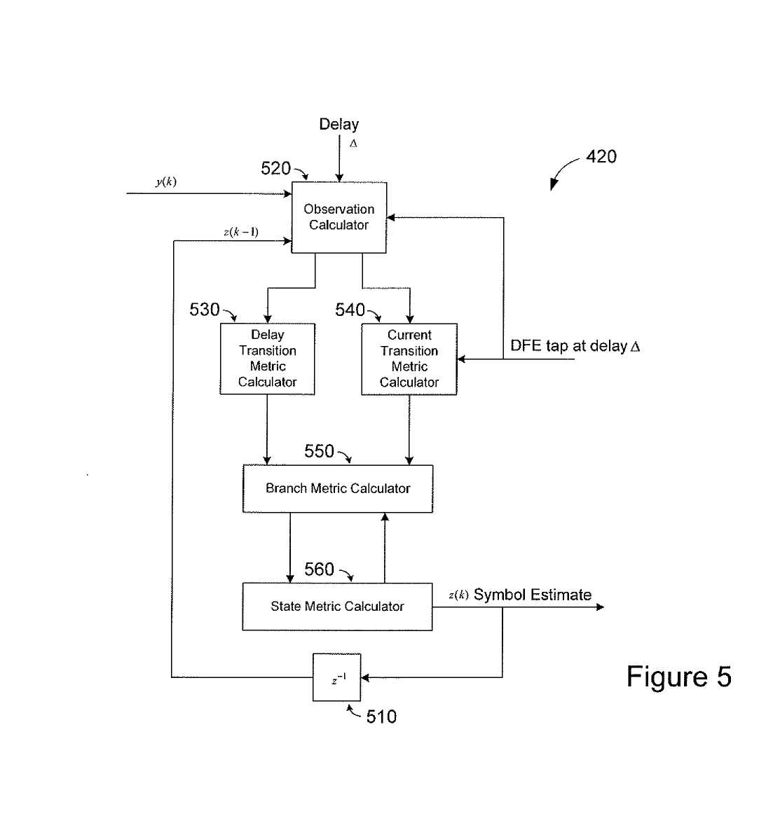

FIG. 5 shows a top level view of the hyper trellis decoder 420 used in an example of the methods and systems to which the current application is directed. The observation calculator 520 receives soft decision sample y(k) from the adder element 510. The observation calculator 520 also receives the programmable input delay Δ and, from the feedback filter 370, the coefficient of the filter at delay Δ or some measure of the coefficient at delay Δ, the observation calculator 520 produces observations for the current transition metric calculator 540 and the delay transition metric calculator 530. The delay transition metric calculator 530 uses the observations from the observation calculator 520 and the symbol alphabet to calculate an array of transition metrics corresponding to the delayed symbol estimate. The current transition metric calculator 540 uses the observations from the observation calculator 520, the programmable delay Δ, and the symbol alphabet to calculate an array of transition metrics corresponding to the current symbol estimate. The branch metric calculator 550 uses the transition metrics, from the delay transition metric calculator 530 and the current transition metric calculator 540, and state metrics from the state metric calculator 560 to calculate an array of branch metrics and an array of branch symbols used in the state metric calculator 560. The state metric calculator 560 uses the array of branch metrics and the array of branch symbols from the branch metric calculator 550 to calculate a symbol estimate z(k), provided to the delay element 510, and state metrics, provided to the branch metric calculator 550. The delay element 510 delays symbol estimate z(k) by one sample and provides a previous symbol estimate z(k−1) to the observation calculator 520.

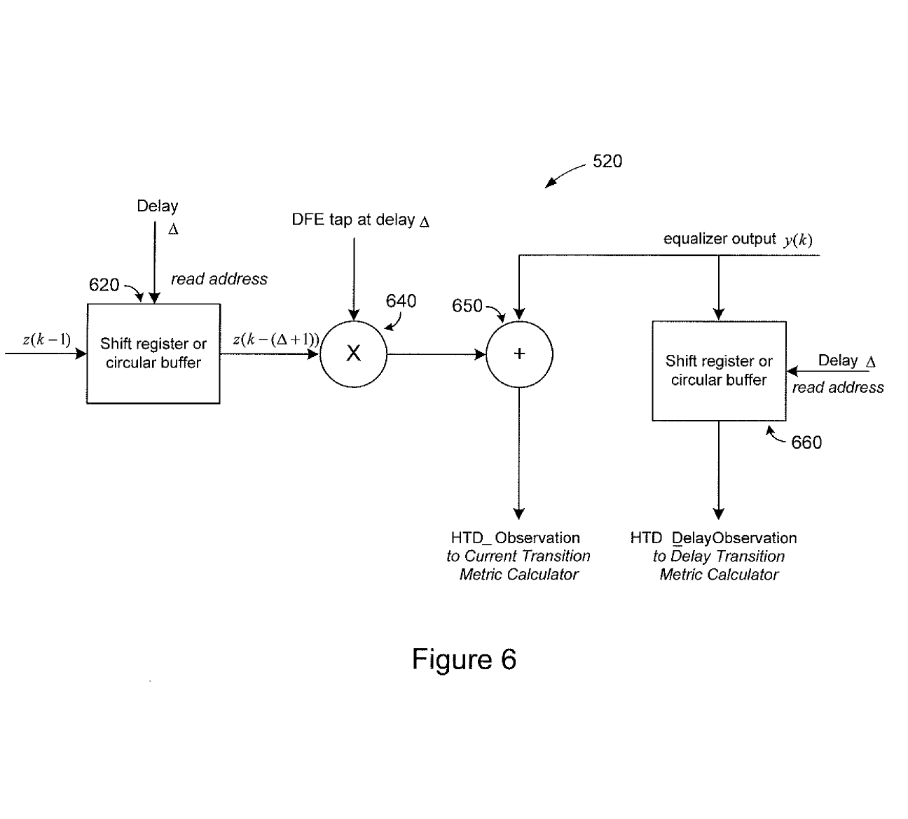

FIG. 6 shows the observation calculator 520 used in an example of the methods and systems to which the current application is directed. The previous symbol estimate z(k−1) from delay element 510, along with the programmable delay Δ, are provided to the shift register/circular buffer 620. The shift register/circular buffer 620 reads the programmable delay Δ and produces the delayed symbol estimate z(k−(Δ+1)) to a multiplier 640. The multiplier 640 multiplies z(k−(Δ+1)) from the shift register/circular buffer 620 with the coefficient of the filter at delay Δ, or some measure of the coefficient at delay Δ, provided from the feedback filter 370. The result of the multiplier 640 is added to the soft decision sample y(k) by an adder 650 to form the observation for current transition metric calculator 540, HTD_Observation, which is expressed as

HTD_Observation=α_{Δ+1}(k)·z(k−(Δ+1)+y(k)

where α_{Δ+1}(k) is the coefficient of the filter at delay Δ or some measure of the coefficient at delay Δ provided from feedback filter 370.

The observation for delay transition metric calculator 530, HTD_DelayObservation, is formed from the shift register/circular buffer 660. Shift register/circular buffer 660 inputs soft decision sample y(k), and, by reading programmable delay Δ, produces the observation for the delay transition metric calculator 530,

HTD_DelayObservation=y(k−Δ)

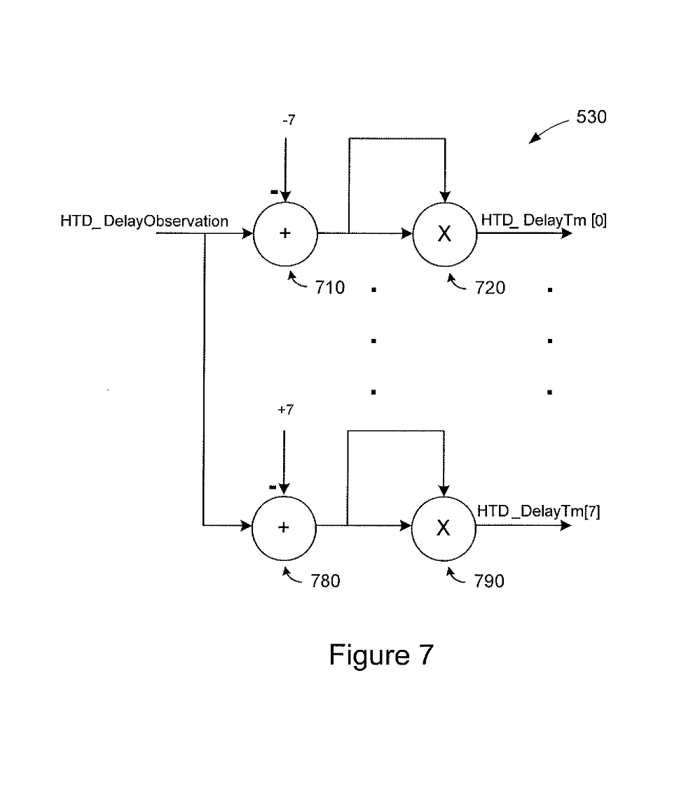

FIG. 7 shows the delay transition metric calculator 530 used in an example of the methods and systems to which the current application is directed. The delay observation HTD_DelayObservation from the observation calculator 520 is used as input to the delay transition metric calculator 530, and for each member of the symbol alphabet, aᵢ ε A, the delay transition metric is calculated according to

HTD_DelayTmᵢ=HTD_DelayObservation−aᵢ

Adders 710 . . . 780 each subtract a symbol value from delay observation HTD_DelayObservation. Here, the 8-level symbol alphabet A={−7,−5,−3,−1,1,3,5,7} is shown for simplicity. The outputs of adders 710 . . . 780 are each squared in multipliers 720 . . . 790, producing the array of delay transition metrics, HTD_DelayTm[i], i=0 . . . 7, for use in branch metric calculator 550.

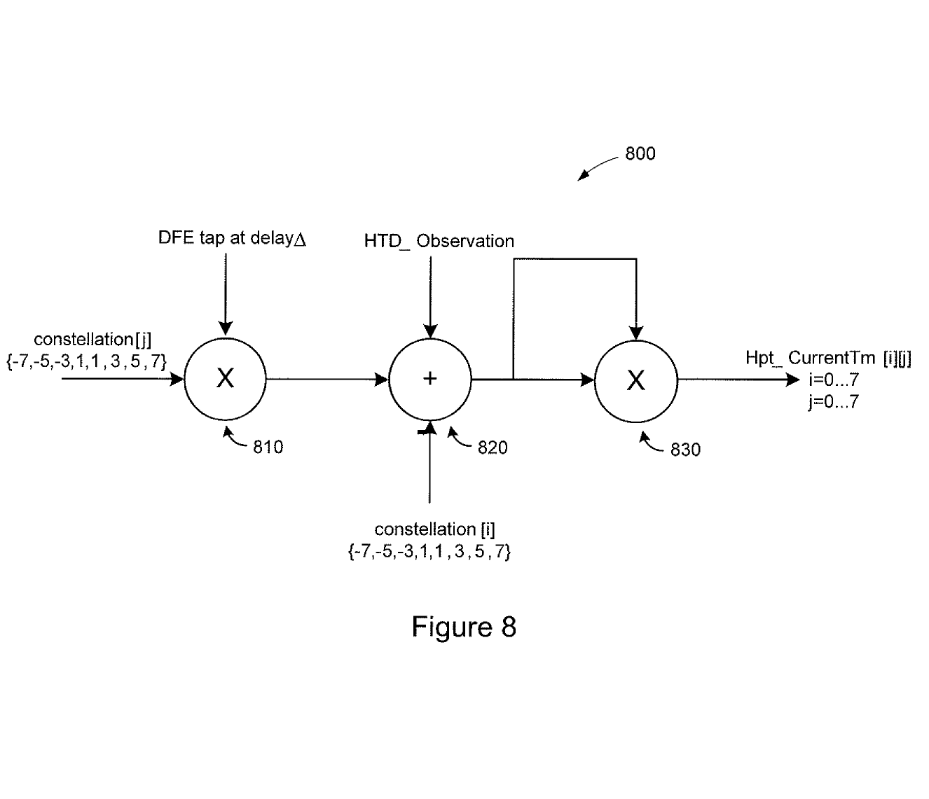

FIG. 8 shows current transition metric calculator 540 used in an example of the methods and systems to which the current application is directed. The current transition metric calculator 540 uses HTD_Observation from the observation calculator 520, and, from the feedback filter 370, the coefficient of the filter at delay Δ, or some measure of the coefficient at delay Δ, to calculate an array of current transition metrics, HTD_CurrentTm[i][j], according to

HTD_CurrentTm[i][j]=(HTD_Observation+aⱼ·α_{Δ+1}(k)−aᵢ)²

with i=0 . . . 7, j=0 . . . 7, continuing again with the 8-level symbol alphabet A={−7,−5,−3,−1,1,3,5,7} for simplicity. Observe that the current transition metrics are calculated using all possible combinations of alphabet members.

The multiplier 810 multiplies alphabet member aⱼ=0 . . . 7 with the coefficient of the filter at delay Δ, or some measure of the coefficient at delay Δ, from the feedback filter 370. The adder 820 sums the output of the multiplier 810 with HTD_Observation from the observation calculator 520 and subtracts alphabet member aᵢ, i=0 . . . 7 from the result, which is squared in multiplier 830 to form the array of current transition metrics, HTD_CurrentTm[i][j].

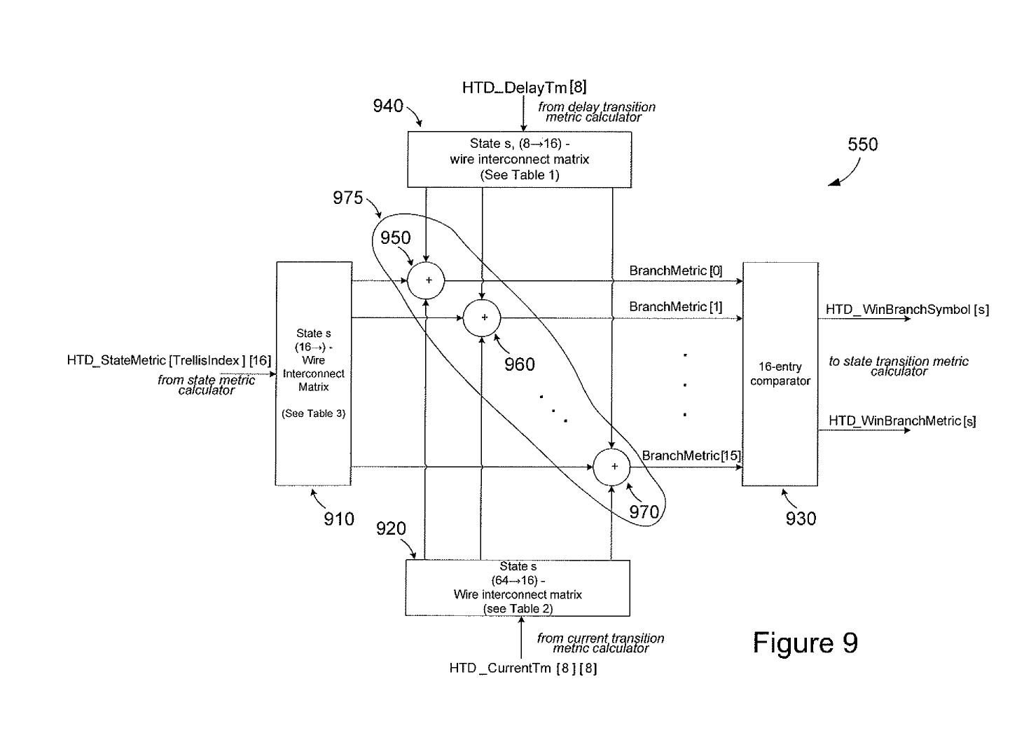

FIG. 9 shows the branch metric calculator 550 used in an example of the methods and systems to which the current application is directed. The branch metric calculator 550 calculates the branch metrics associated with the hypertrellis. In the two-dimensional case represented by the hypertrellis in FIG. 13, for example, each new state results in incoming transitions from four previous states. Each transition is a result of changes in four different bits (i.e. two bits from each four-state trellis in FIG. 12), implying four possible branches. Thus, the total number of incoming branches for each new state is sixteen, for a total of 256 branches given sixteen separate code states. The branch metrics can be assembled efficiently by combining the previously calculated and stored delayed and current transition metrics from calculators 530 and 540, respectively. Furthermore, path metrics for the trellis can also be calculated by adding the path metrics for each previous state to each of the branch metrics. For the purpose of simplicity, the combination of previous path metrics (i.e. HTD_StateMetrics) and transition metrics (i.e. HTD_CurrentTm and HTD_DelayTm) are referred to as the “branch metrics” (i.e. BranchMetric).

The stored metrics HTD_StateMetrics, HTD_CurrentTm, and HTD_DelayTm in the branch metric calculator 550 are combined via wire interconnect matrices 910, 920 and 940. Specifics of the wire interconnect matrices 910, 920, and 940 depend on the trellis encoder used in the signal protocol. The tables describing the specifics of the wire interconnect matrices 910, 920, and 940 are, in one example, those for the ATSC signal format used for DTV signals in the U.S., as described in ATSC Digital Television Standard (A/53) Revision E. Furthermore, also shown is a trellis index, TrellisIndex, 0 . . . 11, accommodating the twelve interleaved trellis encoders in the ATSC standard. Wire interconnect tables can be produced for other trellis encoders, and the currently described sub-system can be modified to accommodate un-encoded data, such as un-encoded data from a training sequence.

Wire interconnect matrix 910 is a 16-to-16 mapping of input to output, mapping the length-16 input array HTD_StateMetric[TrellisIndex][16] from state transition metric calculator 560 to its 16 output terminals, depending on the state S of the trellis decoder. There are twelve interleaved encoders used in the ATSC standard, and the TrellisIndex, 0 . . . 11, is used to denote this nuance. For ATSC-encoded signals, the specific mapping is described in Table 1, provided below:

TABLE 1
Past State Metrics

| | | | Branch | | | | | | | | | | | | | | | |
|---|---|---|---|---|---|---|---|---|---|---|---|---|---|---|---|---|---|---|
| State | S0 | SΔ | 0 | 1 | 2 | 3 | 4 | 5 | 6 | 7 | 8 | 9 | 10 | 11 | 12 | 13 | 14 | 15 |
| 0 | 0 | 0 | 0 | 2 | 0 | 2 | 8 | 10 | 8 | 10 | 0 | 2 | 0 | 2 | 8 | 10 | 8 | 10 |
| 1 | 0 | 1 | 0 | 2 | 2 | 0 | 8 | 10 | 10 | 8 | 0 | 2 | 2 | 0 | 8 | 10 | 10 | 8 |
| 2 | 0 | 2 | 1 | 3 | 1 | 3 | 9 | 11 | 9 | 11 | 1 | 3 | 1 | 3 | 9 | 11 | 9 | 11 |
| 3 | 0 | 3 | 1 | 3 | 3 | 1 | 9 | 11 | 11 | 9 | 1 | 3 | 3 | 1 | 9 | 11 | 11 | 9 |
| 4 | 1 | 0 | 0 | 2 | 0 | 2 | 8 | 10 | 8 | 10 | 8 | 10 | 8 | 10 | 0 | 2 | 0 | 2 |
| 5 | 1 | 1 | 0 | 2 | 2 | 0 | 8 | 10 | 10 | 8 | 8 | 10 | 10 | 8 | 0 | 2 | 2 | 0 |
| 6 | 1 | 2 | 1 | 3 | 1 | 3 | 9 | 11 | 9 | 11 | 9 | 11 | 9 | 11 | 1 | 3 | 1 | 3 |
| 7 | 1 | 3 | 1 | 3 | 3 | 1 | 9 | 11 | 11 | 9 | 9 | 11 | 11 | 9 | 1 | 3 | 3 | 1 |
| 8 | 2 | 0 | 4 | 6 | 4 | 6 | 12 | 14 | 12 | 14 | 4 | 6 | 4 | 6 | 12 | 14 | 12 | 14 |
| 9 | 2 | 1 | 4 | 6 | 6 | 4 | 12 | 14 | 14 | 12 | 4 | 6 | 6 | 4 | 12 | 14 | 14 | 12 |
| 10 | 2 | 2 | 5 | 7 | 5 | 7 | 13 | 15 | 13 | 15 | 5 | 7 | 5 | 7 | 13 | 15 | 13 | 15 |
| 11 | 2 | 3 | 5 | 7 | 7 | 5 | 13 | 15 | 15 | 13 | 5 | 7 | 7 | 5 | 13 | 15 | 15 | 13 |
| 12 | 3 | 0 | 4 | 6 | 4 | 6 | 12 | 14 | 12 | 14 | 12 | 14 | 12 | 14 | 4 | 6 | 4 | 6 |
| 13 | 3 | 1 | 4 | 6 | 6 | 4 | 12 | 14 | 14 | 12 | 12 | 14 | 14 | 12 | 4 | 6 | 6 | 4 |
| 14 | 3 | 2 | 5 | 7 | 5 | 7 | 13 | 15 | 13 | 15 | 13 | 15 | 13 | 15 | 5 | 7 | 5 | 7 |
| 15 | 3 | 3 | 5 | 7 | 7 | 5 | 13 | 15 | 15 | 13 | 13 | 15 | 15 | 13 | 5 | 7 | 7 | 5 |

The elements in the table are the indices of elements of HTD_StateMetric, and the column index is the output terminal of wire interconnect matrix 910.

The wire interconnect matrix 940 is an 8-to-16 mapping of input to output, mapping the length-8 input array HTD_DelayTm[8] from the delay transition metric calculator 530 to its 16 output terminals, depending on the state S of the trellis decoder. For ATSC-encoded signals, the specific mapping is described in Table 2, provided below:

TABLE 2
Delay-Transition-Matrix Cell Address

| | | | Branch | | | | | | | | | | | | | | | |
|---|---|---|---|---|---|---|---|---|---|---|---|---|---|---|---|---|---|---|
| State | S0 | SΔ | 0 | 1 | 2 | 3 | 4 | 5 | 6 | 7 | 8 | 9 | 10 | 11 | 12 | 13 | 14 | 15 |
| 0 | 0 | 0 | 0 | 2 | 4 | 6 | 0 | 2 | 4 | 6 | 0 | 2 | 4 | 6 | 0 | 2 | 4 | 6 |
| 1 | 0 | 1 | 2 | 0 | 4 | 6 | 2 | 0 | 4 | 6 | 2 | 0 | 4 | 6 | 2 | 0 | 4 | 6 |
| 2 | 0 | 2 | 1 | 3 | 5 | 7 | 1 | 3 | 5 | 7 | 1 | 3 | 5 | 7 | 1 | 3 | 5 | 7 |
| 3 | 0 | 3 | 3 | 1 | 5 | 7 | 3 | 1 | 5 | 7 | 3 | 1 | 5 | 7 | 3 | 1 | 5 | 7 |
| 4 | 1 | 0 | 0 | 2 | 4 | 6 | 0 | 2 | 4 | 6 | 0 | 2 | 4 | 6 | 0 | 2 | 4 | 6 |
| 5 | 1 | 1 | 2 | 0 | 4 | 6 | 2 | 0 | 4 | 6 | 2 | 0 | 4 | 6 | 2 | 0 | 4 | 6 |
| 6 | 1 | 2 | 1 | 3 | 5 | 7 | 1 | 3 | 5 | 7 | 1 | 3 | 5 | 7 | 1 | 3 | 5 | 7 |
| 7 | 1 | 3 | 3 | 1 | 5 | 7 | 3 | 1 | 5 | 7 | 3 | 1 | 5 | 7 | 3 | 1 | 5 | 7 |
| 8 | 2 | 0 | 0 | 2 | 4 | 6 | 0 | 2 | 4 | 6 | 0 | 2 | 4 | 6 | 0 | 2 | 4 | 6 |
| 9 | 2 | 1 | 2 | 0 | 4 | 6 | 2 | 0 | 4 | 6 | 2 | 0 | 4 | 6 | 2 | 0 | 4 | 6 |
| 10 | 2 | 2 | 1 | 3 | 5 | 7 | 1 | 3 | 5 | 7 | 1 | 3 | 5 | 7 | 1 | 3 | 5 | 7 |
| 11 | 2 | 3 | 3 | 1 | 5 | 7 | 3 | 1 | 5 | 7 | 3 | 1 | 5 | 7 | 3 | 1 | 5 | 7 |
| 12 | 3 | 0 | 0 | 2 | 4 | 6 | 0 | 2 | 4 | 6 | 0 | 2 | 4 | 6 | 0 | 2 | 4 | 6 |
| 13 | 3 | 1 | 2 | 0 | 4 | 6 | 2 | 0 | 4 | 6 | 2 | 0 | 4 | 6 | 2 | 0 | 4 | 6 |
| 14 | 3 | 2 | 1 | 3 | 5 | 7 | 1 | 3 | 5 | 7 | 1 | 3 | 5 | 7 | 1 | 3 | 5 | 7 |
| 15 | 3 | 3 | 3 | 1 | 5 | 7 | 3 | 1 | 5 | 7 | 3 | 1 | 5 | 7 | 3 | 1 | 5 | 7 |

The elements in the table are the indices of elements of HTD_DelayTm, and the column index is the output terminal of wire interconnect matrix 940.

The wire interconnect matrix 920 is a 64-to-16 mapping of input to output, mapping the 8×8 input array HTD_CurrentTm[8][8] from the current transition metric calculator 540 to its 16 output terminals, depending on the state S of the trellis decoder. For ATSC-encoded signals, the specific mapping is described in Table 3, provided below:

TABLE 3
Current-Transition-Matrix Cell Address Pairs (Current, Delayed)

| | | | Branch | | | | | | | | | | | | | | | |
|---|---|---|---|---|---|---|---|---|---|---|---|---|---|---|---|---|---|---|
| State | S0 | SΔ | 0 | 1 | 2 | 3 | 4 | 5 | 6 | 7 | 8 | 9 | 10 | 11 | 12 | 13 | 14 | 15 |
| 0 | 0 | 0 | (0, 0) | (0, 2) | (0, 4) | (0, 6) | (2, 0) | (2, 2) | (2, 4) | (2, 6) | (4, 0) | (4, 2) | (4, 4) | (4, 6) | (6, 0) | (6, 2) | (6, 4) | (6, 6) |
| 1 | 0 | 1 | (0, 2) | (0, 0) | (0, 4) | (0, 6) | (2, 2) | (2, 0) | (2, 4) | (2, 6) | (4, 2) | (4, 0) | (4, 4) | (4, 6) | (6, 2) | (6, 0) | (6, 4) | (6, 6) |
| 2 | 0 | 2 | (0, 1) | (0, 3) | (0, 5) | (0, 7) | (2, 1) | (2, 3) | (2, 5) | (2, 7) | (4, 1) | (4, 3) | (4, 5) | (4, 7) | (6, 1) | (6, 3) | (6, 5) | (6, 7) |
| 3 | 0 | 3 | (0, 3) | (0, 1) | (0, 5) | (0, 7) | (2, 3) | (2, 1) | (2, 5) | (2, 7) | (4, 3) | (4, 1) | (4, 5) | (4, 7) | (6, 3) | (6, 1) | (6, 5) | (6, 7) |
| 4 | 1 | 0 | (2, 0) | (2, 2) | (2, 4) | (2, 6) | (0, 0) | (0, 2) | (0, 4) | (0, 6) | (4, 0) | (4, 2) | (4, 4) | (4, 6) | (6, 0) | (6, 2) | (6, 4) | (6, 6) |
| 5 | 1 | 1 | (2, 2) | (2, 0) | (2, 4) | (2, 6) | (0, 2) | (0, 0) | (0, 4) | (0, 6) | (4, 2) | (4, 0) | (4, 4) | (4, 6) | (6, 2) | (6, 0) | (6, 4) | (6, 6) |
| 6 | 1 | 2 | (2, 1) | (2, 3) | (2, 5) | (2, 7) | (0, 1) | (0, 3) | (0, 5) | (0, 7) | (4, 1) | (4, 3) | (4, 5) | (4, 7) | (6, 1) | (6, 3) | (6, 5) | (6, 7) |
| 7 | 1 | 3 | (2, 3) | (2, 1) | (2, 5) | (2, 7) | (0, 3) | (0, 1) | (0, 5) | (0, 7) | (4, 3) | (4, 1) | (4, 5) | (4, 7) | (6, 3) | (6, 1) | (6, 5) | (6, 7) |
| 8 | 2 | 0 | (1, 0) | (1, 2) | (1, 4) | (1, 6) | (3, 0) | (3, 2) | (3, 4) | (3, 6) | (5, 0) | (5, 2) | (5, 4) | (5, 6) | (7, 0) | (7, 2) | (7, 4) | (7, 6) |
| 9 | 2 | 1 | (1, 2) | (1, 0) | (1, 4) | (1, 6) | (3, 2) | (3, 0) | (3, 4) | (3, 6) | (5, 2) | (5, 0) | (5, 4) | (5, 6) | (7, 2) | (7, 0) | (7, 4) | (7, 6) |
| 10 | 2 | 2 | (1, 1) | (1, 3) | (1, 5) | (1, 7) | (3, 1) | (3, 3) | (3, 5) | (3, 7) | (5, 1) | (5, 3) | (5, 5) | (5, 7) | (7, 1) | (7, 3) | (7, 5) | (7, 7) |
| 11 | 2 | 3 | (1, 3) | (1, 1) | (1, 5) | (1, 7) | (3, 3) | (3, 1) | (3, 5) | (3, 7) | (5, 3) | (5, 1) | (5, 5) | (5, 7) | (7, 3) | (7, 1) | (7, 5) | (7, 7) |
| 12 | 3 | 0 | (3, 0) | (3, 2) | (3, 4) | (3, 6) | (1, 0) | (1, 2) | (1, 4) | (1, 6) | (5, 0) | (5, 2) | (5, 4) | (5, 6) | (7, 0) | (7, 2) | (7, 4) | (7, 6) |
| 13 | 3 | 1 | (3, 2) | (3, 0) | (3, 4) | (3, 6) | (1, 2) | (1, 0) | (1, 4) | (1, 6) | (5, 2) | (5, 0) | (5, 4) | (5, 6) | (7, 2) | (7, 0) | (7, 4) | (7, 6) |
| 14 | 3 | 2 | (3, 1) | (3, 3) | (3, 5) | (3, 7) | (1, 1) | (1, 3) | (1, 5) | (1, 7) | (5, 1) | (5, 3) | (5, 5) | (5, 7) | (7, 1) | (7, 3) | (7, 5) | (7, 7) |
| 15 | 3 | 3 | (3, 3) | (3, 1) | (3, 5) | (3, 7) | (1, 3) | (1, 1) | (1, 5) | (1, 7) | (5, 3) | (5, 1) | (5, 5) | (5, 7) | (7, 3) | (7, 1) | (7, 5) | (7, 7) |

The elements in the table are the indices (i,j) of elements of HTD_CurrentTm[i]]j], and the column index is the output terminal of wire interconnect matrix 920.

The sixteen outputs of the wire interconnect matrices 910, 920, and 940 are summed in the adder array 975, containing sixteen adders for ATSC, adder 950, adder 960, . . . adder 970. Adder 950 sums the 0^{th} output terminals of wire interconnect matrices 910, 920, and 940 and produces BranchMetric[0]; adder 960 sums the 1^{st} output terminals of wire interconnect matrices 910, 920, and 940 and produces BranchMetric[1]; . . . adder 970 sums the 15^{th} output terminals of wire interconnect matrices 910, 920, and 940 and produces BranchMetric[15]. The branch metric array BranchMetric[i], i=0 . . . 15, is provided to comparator 930.

For each state S=0 . . . 15 of the decoder, the comparator 930 compares the array of branch metrics, and assigns the lowest branch metric among the array BranchMetric[i] to the S^{th} position of the output array HTD_WinBranchMetric[s]. Furthermore, the comparator 930 assigns the alphabet member associated with the lowest branch metric to the S^{th} position of output array HTD_WinBranchSymbol[s].

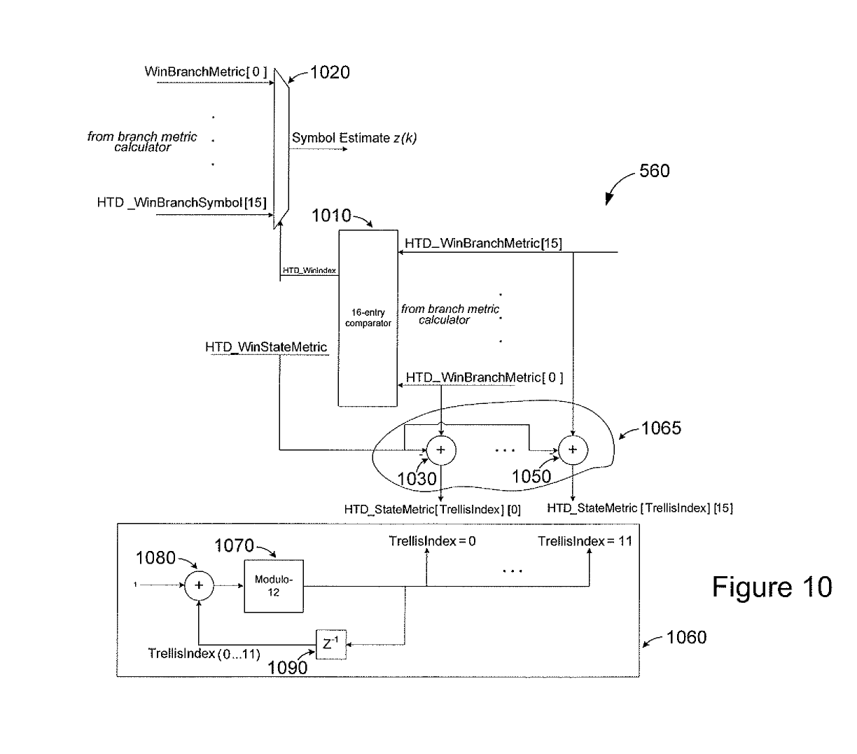

FIG. 10 shows the state transition metric calculator 560 used in an example of the methods and systems to which the current application is directed. The comparator 1010 receives the array of winning branch metrics, HTD_WinBranchMetric[s], S=0 . . . 15, from the branch metric calculator 550. The comparator 1010 selects the index of the array corresponding to the lowest element of the array, assigns it to HTD_WinIndex, and assigns the lowest element itself to HTD_WinStateMetric. The multiplexer 1020 receives the array of winning branch symbols, HTD_WinBranchSymbol[s], S=0 . . . 15, from branch metric calculator 550 and assigns the element of HTD_WinBranchSymbols[s] to symbol estimate z(k) according to the value of HPT_WinIndex provided from the comparator 1010. The estimate z(k) for s(k) is fed back into observation calculator 520 and decision feedback filter 370. Note that the HTD decoding process also yields a new estimate z(k−Δ) for s(k−Δ) which can be used to replace the previous estimate in the decision feedback filter.

The winning state metric HTD_WinStateMetric from comparator 1010 is subtracted from each element of array HTD_WinBranchMetric[s], S=0 . . . 15, in adder array 1065, which includes exemplary adders 1030 . . . 1050, to form the array of state metrics, HTD_StateMetric[TrellisIndex] [s], S=0 . . . 15, which are used in the branch metric calculator 550. This is an implementation-specific technique used to normalize the accumulated metrics. Other normalization techniques can be applied in alternative examples.

The trellis index circuitry 1060 reflects the ATSC DTV standard and is used to generate the trellis index, TrellisIndex=0 . . . 11. Adder 1080 increments, by one, the contents of register 1090, and the result is constrained to 0 . . . 11 using modulo-12 arithmetic in modulo-12 block 1070. The result TrellisIndex is used for the twelve interleaved trellis encoders in the ATSC standard.

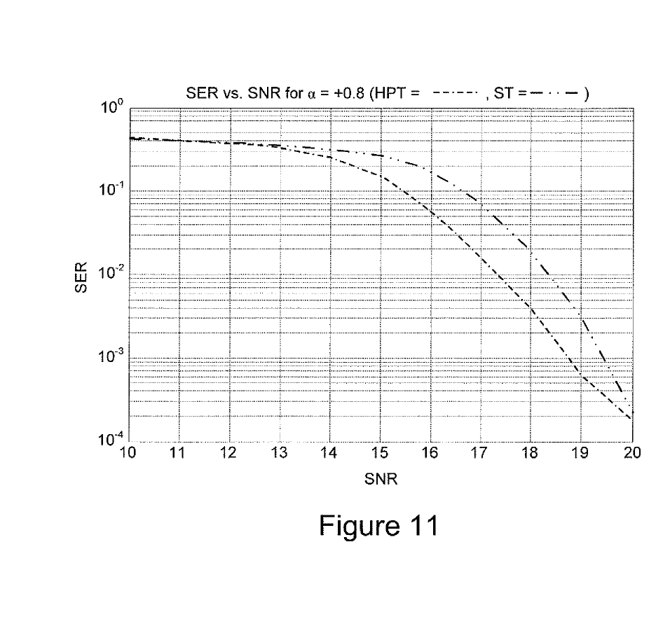

FIG. 11 shows symbol error rate (SER) versus signal-to-noise ratio (SNR) simulation results for 8-level signaling illustrating the benefits of the currently-discussed method and system. A conventional, currently available trellis decoder and the hyper trellis decoder are compared, with a single echo channel model, 1+α·z^{-Δ}. The operating point for 8-level signaling according to ATSC corresponding to threshold of visibility is approximately a SER of 20%. At this error rate, the currently-discussed method and system shows a full dB of improvement in SNR, from about 18.3 dB to about 17.3 dB, which is significant in terms of coverage area of the DTV broadcast.

The equations described in the above disclosure may include scaling, change of sign, or similar constant modifications that are not shown for simplicity. Such modifications can be readily determined or derived for the particular implementation. Thus, the described equations may be subject to such modifications, and are not limited to the exact forms presented herein.

The various functions of equalization, signal combining, error correction, and carrier recovery may be implemented with circuit elements or may also be implemented in the digital domain as processing steps carried out by computer instructions, stored in a mass-storage device, electronic memory, or other such physical computer-readable medium, and executed by one or more processors, microprocessors, digital-signal processors, or micro-controllers.

The present invention can be embodied in the form of methods and apparatuses for practicing those methods. The present invention can also be embodied in the form of program code embodied in tangible media, such as floppy diskettes, CD-ROMs, hard drives, or any other physical machine-readable storage medium, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The phrase “computer-readable medium” does not include or encompass electromagnetic signals and other such non-physical media which do not store data, but only transmit data.

Although the present invention has been described in terms of particular embodiments, it is not intended that the invention be limited to these embodiments. Modifications within the spirit of the invention will be apparent to those skilled in the art. For example, the present invention may be implemented to provide a multiple-non-contiguous-symbol-estimation decision feedback equalizer to process signals encoded by any of many different types of encoding and provide estimation of three or greater symbols. The above-described circuitry and control logic can be modified by modifying any of many different implementation and design parameters, including parameters that control choice of integrated-circuit technology, programming language, operating-system or other underlying control program, modular organization, control structures, data structures, and many of such design and implementation parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method carried out by a communications receiver having a decision feedback equalizer, the method comprising:
receiving, by the decision feedback equalizer, a first sequence of processed symbols;
processing the first sequence of processed symbols by carrying out a symbol-estimation operation for each symbol of the received first sequence of processed symbols, the symbol-estimation operation estimating, for a currently-considered symbol, a corresponding processed symbol as well as a processed-symbol value for at least one additional symbol of the timed and data-synchronized signal; and
outputting a second sequence of processed symbols corresponding to the first sequence of processed symbols.

2. The method of claim 1 wherein the corresponding at least one additional symbol corresponds to a symbol that is not adjacent, in the sequence of symbols, to the currently-considered symbol.

3. The method of claim 1 further including estimating, for a currently-considered symbol, a corresponding processed symbol by considering all possible symbols, under the channel-coding constraint, and selecting a symbol with greatest likelihood to correspond to the currently-considered symbol in an original sequence of symbols transmitted to the communications receiver and suffering echo distortion during transmission.

4. The method of claim 1 wherein the symbol-estimation operation includes:
receiving first sequence of processed symbols;
receiving a programmable input delay;
receiving an indication of a filter coefficient;
receiving a previous symbol estimate; and
generating the corresponding processed symbol as well as the processed-symbol value for at least one additional symbol using the received first sequence of processed symbols, programmable input delay, previous symbol estimate, and indication of the filter coefficient.

5. The method of claim 4 wherein generating the corresponding processed symbol as well as the processed-symbol value for at least one additional symbol further includes:
providing the previous symbol estimate and the programmable input delay to a first shift register/circular buffer;
producing, by the first shift register/circular buffer, a delayed symbol estimate that is forwarded to a multiplier;
multiplying the previous symbol estimate by the indication of the filter coefficient by the multiplier and transmitting a multiplication result to an adder;
adding the multiplication result, by the adder, with a symbol of the first sequence of processed symbols to produce an output signal to a current transition metric calculator;
providing the symbol of the first sequence of processed symbols and the indication of the filter coefficient to a second shift register/circular buffer; and
producing, by the second shift register/circular buffer, an output signal to a delay transition metric calculator.

6. The method of claim 5 wherein output signals from the current transition metric calculator and the delay transition metric calculator are input to a branch metric calculator, to which state metrics are input from a state metric calculator, the branch metric calculator outputting branch metrics that are input to the state metric calculator.

7. The method of claim 6 wherein the state metric calculator, in addition to producing the state metrics input to the branch metric calculator, produces the processed symbol as well as the processed-symbol value for at least one additional symbol.

8. A feedback equalizer comprising:
a forward processing block that receives a timed and data-synchronized signal that includes echo distortions and that represents a sequence of symbols and symbol estimates produced by a decoder and that outputs a forward-filtered timed and data-synchronized signal that includes echo distortions;
an arithmetic-operation unit that combines the forward-filtered timed and data-synchronized signal with a feedback-filter output to produce a first sequence of processed signals corresponding to the received timed and data-synchronized signal with fewer echo distortions than the received timed and data-synchronized signal;
a decoder that receives the first sequence of processed signals from the arithmetic-operation unit, a delay value that specifies a second symbol in the sequence of symbols prior to a currently considered symbol, and an indication of a coefficient of a filter at the delay value and that produces estimates of the processed symbols as a second sequence of processed symbols; and
a feedback filter that receives the second sequence of processed symbols and outputs the feedback filter output.

9. The feedback equalizer of claim 8 wherein the corresponding at least one additional symbol corresponds to a symbol that is not adjacent, in the sequence of symbols, to the currently-considered symbol.

10. The feedback equalizer of claim 8 wherein the decoder comprises:
an observation calculator;
a delay transition metric calculator;
a current transition metric calculator;
a branch metric calculator; and
a state metric calculator.

11. The feedback equalizer of claim 10 wherein the observation calculator receives the first sequence of processed symbols, the delay value, the indication of the filter coefficient, and a previous symbol estimate and outputs a first signal to the delay transition metric calculator and a second signal to the current transition metric calculator by:
providing the previous symbol estimate and the delay value to a first shift register/circular buffer;
producing, by the first shift register/circular buffer, a delayed symbol estimate that is forwarded to a multiplier;
multiplying the previous symbol estimate by the indication of the filter coefficient by the multiplier and transmitting a multiplication result to an adder;
adding the multiplication result, by the adder, with a symbol of the first sequence of processed symbols to produce the second signal output to the current transition metric calculator;
providing the symbol of the first sequence of processed symbols and the indication of the filter coefficient to a second shift register/circular buffer; and
producing, by the second shift register/circular buffer, the first signal output to the delay transition metric calculator.

12. The feedback equalizer of claim 11 wherein signals output from the current transition metric calculator and the delay transition metric calculator are input to the branch metric calculator, to which state metrics are input from the state metric calculator, the branch metric calculator outputting branch metrics that are input to the state metric calculator.

13. The feedback equalizer of claim 12 wherein the state metric calculator, in addition to producing the state metrics input to the branch metric calculator, produces the processed symbol as well as the processed-symbol value for at least one additional symbol.
